(19) United States
(12) Patent Application Publication
(10) Pub. No.: US 2007/0172629 A1
(43) Pub. Date: Jul. 26, 2007

(54) RECYCLABLE SURFACE COVERING AND METHOD OF MANUFACTURING

(76) Inventor: Arthur B. Dodge, Lancaster, PA (US)

Correspondence Address: BARLEY SNYDER, LLC, 1000 WESTLAKES DRIVE, SUITE 275, BERWYN, PA, 19312, US

(21) Appl. No.: 11/468,741

(22) Filed: Aug. 30, 2006

Related U.S. Application Data
(63) Continuation-in-part of application No. 11/336,116, filed on Jan. 20, 2006.

(51) Int. Cl. B32B 33/00; B05D 1/16

(52) U.S. Cl. 428/90; 428/97; 428/95; 427/197; 427/200; 427/202; 427/206

(57) ABSTRACT

A surface covering is provided, comprising a substrate with a flocking layer adhered to the substrate by an adhesive. The substrate is formed at least partially from granulated recycled rubber and a binding agent. In an exemplary embodiment, a design is applied to the flocking layer. A method of manufacturing the surface covering comprises the steps of producing a substrate formed at least partially from granulated recycled rubber and a binding agent, flocking the substrate with fibers of a selected base color to form a base covering, printing a transfer paper with a design and transferring the design from the transfer paper to fibers of the base covering.

### RELATED APPLICATION DATA

This application is a continuation in part of application Ser. No. 11/336,116 filed on Jan. 20, 2006.

### FIELD OF THE INVENTION

The invention relates to a surface covering and more particularly to a decorative surface covering that is recyclable and to a method of manufacturing the decorative surface covering.

### BACKGROUND

Floor coverings are widely used to provide aesthetic appeal and also to provide acoustic properties suitable for the environment in which they are used.

Over 5 billion square feet of carpet is installed in North America each year, and presently, roughly an equivalent amount requires disposal. Typically, this discarded carpet is placed in landfills. In 2002, members of the carpet industry and government representatives at the federal, state and local levels sanctioned the Carpet America Recovery Effort (CARE), which has a goal of reducing by forty percent (40%), the amount of carpet that is disposed of in the nation's landfills by the year 2012. To accomplish this goal, ways are being sought to encourage recycling used carpet.

Presently, less than one percent (1%) of discarded carpet is recycled each year. This low rate of recycling is due, in part, to the fact that traditional carpet products consist of dissimilar materials. For example, nylon fibers may be knitted or woven into a matrix with a urethane or latex backing. It is generally undesirable in making new products from recycled material to commingle materials such as nylon from carpet fibers with urethane or latex from carpet backings. Hence, in addition to logistical and contamination concerns, a fundamental problem with carpet recycling is that the fibers and backing cannot be commingled. For this reason, it is presently impossible to produce new carpet from old carpet.

Poor acoustic properties are extremely undesirable in residential and office structures, as the occupants of one floor do not want to be disturbed by the occupants of the floor above. Sound that is transmitted through the building structure (impact sound) can be particularly troublesome in multiple-floor buildings. In fact, standards have been developed and modified to insure that sound is not transmitted. The ASTM Impact Sound related tests are E492-90 and E989-89. Where noise codes exist, generally IIC50 is specified.

Woven and knitted carpets are well suited to absorbing impact sound and are widely used as floor coverings in office and residential environments. These carpets, however, have several disadvantages. Disposal of worn or soiled carpets can be problematic, both from an environmental and from a cost perspective. Also, providing a wide variety of patterns and particularly custom patterns can be costly.

One alternative to woven and knitted carpets is a flocked floor covering. Existing flocked floor coverings comprise nylon fibers electrostatically flocked onto a poly vinyl chloride (PVC) backing. A glass fiber layer is added between the PVC backing and the flocking to provide dimensional stability. The flocked floor covering is screen printed to provide a range of patterns and colors. This floor covering suffers from several disadvantages. PVC is not recyclable and is a hazardous material, causing handling and disposal problems. Also, the need for a glass fiber layer increases manufacturing complexity and cost and adds to the products non-recyclability. Additionally, the method of manufacturing and distribution of the existing screen printed PVC based floor covering involves screen printing at the point of carpet manufacture and warehousing of each printed pattern, much like traditional woven and knitted carpets. This process limits the number of patters to those are in demand and worthy of utilizing warehouse space. This process also limits patterns to those that are typically designed by the carpet manufacturer who produces the screens. Warehousing is therefore required for each pattern and color combination thus contributing to the cost of the floor covering. The increased cost limits uses of the floor covering to those applications where it will applied in a permanent or long term application and makes it less desirable for short term applications or on other surfaces such as walls. As an example, a need exists for a temporary, and preferably recyclable, floor covering for in-store advertising wherein the flooring can advertise a product or event.

Accordingly, a need exists for a surface covering which provides desirable functionality, acoustic properties and greater pattern versatility and which can be recycled into new surface covering and/or other recycled materials.

### SUMMARY

A surface covering is provided, comprising a substrate with a flocking layer adhered to the substrate by an adhesive. The substrate is formed from granulated rubber and a binding agent, with at least a portion of the granulated rubber being recycled from used surface covering. In a preferred exemplary embodiment, a design is applied to the flocking layer. A method of manufacturing the surface covering comprises the steps of producing a substrate formed at least partially from granulated recycled rubber and a binding agent, flocking the substrate with fibers of a selected base color to form a base covering, printing a transfer paper with a design and transferring the design from the transfer paper to fibers of the base covering.

The surface covering, which may be used on floors, walls, and vehicle interiors, provides good acoustic properties, durability, is recyclable, and uses recycled rubber or other organic, bio-based fillers such as cork.

### BRIEF DESCRIPTION OF THE DRAWINGS

Exemplary embodiments of the invention will be described in detail with reference to the accompanying drawing figures, of which:

FIG. 1 is a sectional view of a surface covering according to an exemplary embodiment of the invention;

FIG. 2 shows a manufacturing sequence for forming a surface covering using recycled product according to an exemplary embodiment of the invention;

FIG. 3 shows an exemplary embodiment of a decorative design applied to the surface covering.; and

FIG. 4 shows a manufacturing and distribution method according to an exemplary embodiment of the invention.

### DETAILED DESCRIPTION OF THE EMBODIMENT(S)

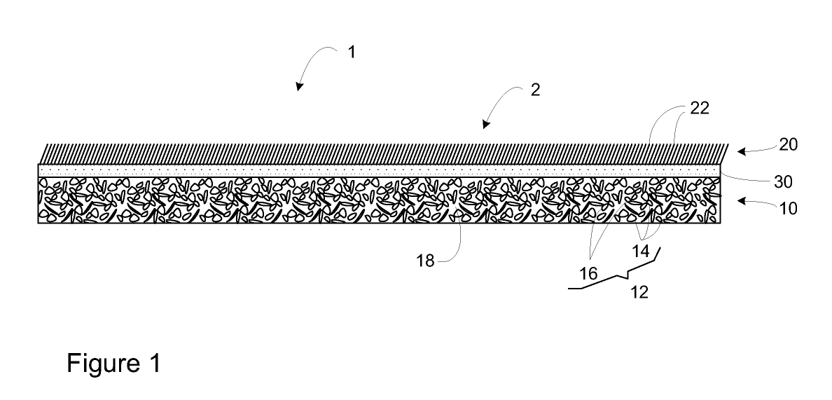

As shown in FIG. 1, a surface covering 1 according to an exemplary embodiment of the present invention comprises a substrate 10 formed from granulated rubber 12 and a binder 18 with a flocking layer 20 adhered to the substrate by an adhesive 30.

In an exemplary embodiment, the granulated rubber 12 is a combination of granulated recycled rubber from recycled surface covering 14 and granulated recycled rubber from other sources 16, such as tires, for example. It should be understood that the relative amounts of recycled rubber from recycled surface covering 14 and granulated recycled rubber from other sources 16 is not limited so that the granulated rubber 12 may be formed entirely of one or the other or any combination thereof. In an exemplary embodiment other fillers such as wood dust, nylon or cork may be utilized in varying amounts. In an exemplary preferred embodiment, the granulated rubber 12 comprises Styrene Butadiene Rubber (SBR). Alternatively, the granulated rubber 12 may comprise other forms, such Ethylene Propylene Diomene Monomer (EDPM), natural rubber or other fillers. Virgin rubber in various forms may also be added in granulated form, but is not required to practice the invention. In an exemplary preferred embodiment, the substrate 10 comprises at least 10 wt-% of granulated recycled rubber or nylon from recycled surface covering 14. The granulated rubber 12 may vary in particle size according to the desired porosity and resulting impact sound absorption properties of the finished substrate 10. In an exemplary embodiment, the grain size may vary between about 0.5 mm and 3.0 mm.

The granulated rubber 12 is combined with a binder 18, and compressed at ambient temperature to form a billet of recycled rubber (not shown). The substrate 10 is formed from the billet. In an exemplary embodiment, the billet is cylindrical in shape, and is shaved by rotating the cylindrical billet while introducing a blade against the billet to form a continuous substrate 10 that is flexible enough to be rolled and provides desirable void distribution. The substrate 10 has good dimensional stability, and provides good impact sound properties. In an exemplary embodiment, the binder 18 is polyurethane, which is added to the granulated rubber 12 as a foam and is set or cured by applying pressure.

An adhesive layer 30 is applied to a front face of the substrate 10, and a flocking layer 20 is adhered to the substrate 10 by the adhesive layer 30. The adhesive may be any adhesive suitable for adhering fibers of the flocking layer 20 to a rubber substrate. For example, polymeric adhesives, such as urethane adhesives, latex adhesives, and particularly acrylic adhesives, are well suited for use in the present invention. In an exemplary embodiment, the flocking layer comprises fibers 22, which are made using a polymeric material, such as nylon and which are colored to be a desirable base color for further application of pattern or decorative design as will be described below. The quantity, length, and denier of the fibers may vary depending upon the application, and are selected to provide the desired look and feel of the covering. The fibers 22 may be applied to the adhesive using any known flocking technique suitable for the fibers 22 and adhesive selected. In an exemplary embodiment, the fiber density is between about 200 and 300 grams per square yard, and the fiber length is between about 2.0 mm and 3.0 mm. In an exemplary embodiment more than 70,000,000 fibers per square yard are applied. In an exemplary embodiment at this stage, the surface covering 1 will be referred to as the base covering 2.

To enhance the aesthetic quality of the base covering 2, a decorative design may be formed on the flocking layer 20 forming the finished surface covering 1. In an exemplary embodiment, the design may be formed by a screen printing process, wherein ink is applied to the surface of the fibers 22 in the flocking layer at locations corresponding to the desired design.

In an alternate embodiment, a dye sublimation process is used to apply the decorative design, wherein the dye is printed onto a transfer medium known such as a transfer paper, then the transfer medium is placed against the surface of the flocking layer 20 and heat is applied. The heat converts the dye to a gaseous state and opens pores in the fibers 22 allowing the ink to penetrate the surface of the fibers 22. The dye sublimation process provides a design that is more durable than a design printed onto the surface of the fibers 22. In an embodiment of the invention, inks specially formulated for application to nylon fibers and commercially available from TransprintUSA, Harrisonburg, Va. are utilized in the dye sublimation process. These commercially available inks are environmentally friendly in that they contain no heavy metals, ozone depleting substances or amine-releasing dyes. Such features advantageously contribute to the ultimate recycability of the surface covering 1.

To facilitate handling and installation, the surface covering 1 may be provided in tiles or continuous sheets. Moreover, the continuous sheets may be rolled. In the case of rolled continuous sheets, the surface covering 1 may be transported to the installation site in the rolled form. The surface covering 1 can then be unrolled and applied to the desired surface at the installation site. Depending upon the size of the surface to be covered, multiple continuous sheets of the surface covering 1 may need to be applied adjacent one another, aligning the pattern as required. The surface covering 1 may be applied by taping it with double faced carpet tape or by gluing it with releasable or other forms of carpet adhesive.

While the surface covering 1 is well suited to use on residential and/or commercial environments to provide impact sound absorption, the surface covering 1 of the present invention is relatively thin and inexpensive, while providing good sound properties, and therefore may also be utilized in vehicles as interior trim or even as a wall covering.

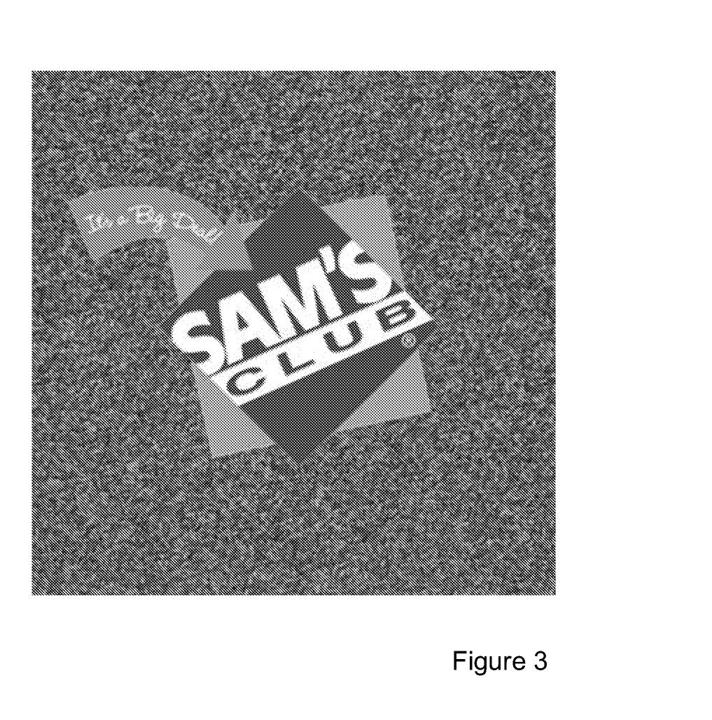

An advantage of the present invention is that the surface covering 1 can be recycled, and accordingly, the surface covering can comprise recycled material, including recycled surface covering. The relatively inexpensive, recyclable, and pattern versatile natures of the surface covering 1 make it attractive for use in short term or temporary applications such as kiosks, point of sale, trade show and product displays. An example of such use is shown in FIG. 3. Here, the decorative design applied to the base covering 2 is a company logo. Such an application may be installed on a floor at random locations in an aisle where tiles or roles of the surface covering 1 have been applied. Alternatively, a feature product description of picture may applied to the base covering 1 and that piece of surface covering 1 may be changed out and recycled frequently while leaving the rest of the floor covering in place. In yet another alternative, the base covering 1 may have a seasonal decorative design applied thereto, for example green grass, pathways, logos, product pictures/features, etc. to promote seasonal products in an area of a store. The graphical possibilities are many and not limited in any way by this exemplary description.

Next, a method for manufacturing a surface covering 1 according to an exemplary embodiment of the invention will be described.

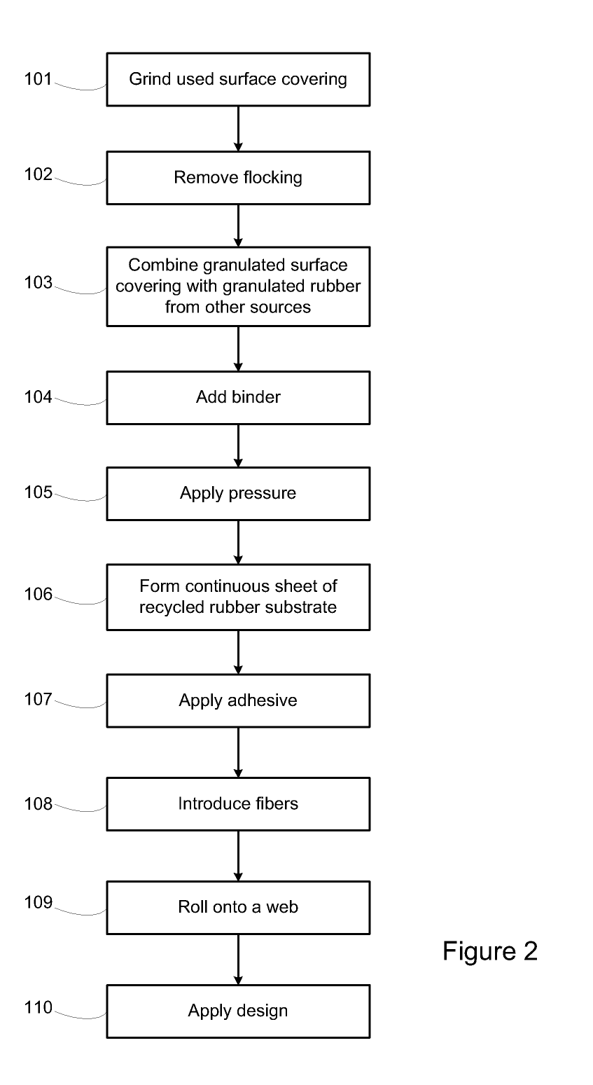

As shown in FIG. 2, when the surface covering becomes worn or soiled, it can be removed and ground to form granulated recycled surface covering 14 (step 101). The surface covering may, for example, be ground using grinding equipment available for grinding tires for recycling. In an exemplary embodiment, at least some of the flocking is removed using a vacuum system (step 102), which may be a dust collection system that is used to remove tire cord when tires are ground for recycling.

The granulated surface covering may be combined with granulated rubber from other sources (step 103). The granulated rubber from other sources may be recycled granulated rubber, such as from tires, or may be virgin granulated rubber, or a combination of the two. The granulated rubber mixture is combined with a binder 18 (step 104) and pressure is applied (step 105) to set or cure the granulated rubber and binder mixture. The binder 18 is preferably polyurethane foam. The container may be a cylindrical container, thereby forming a cylindrical recycled rubber billet comprising granulated recycled rubber and binder.

Next, a continuous sheet of recycled rubber substrate 10 is formed (step 106) by rotating the cylindrical recycled rubber billet and introducing a blade at the outside surface of the billet. The blade is biased into the billet to shave off a continuous layer of the billet.

An adhesive is applied to the continuous sheet of recycled rubber substrate 10 (step 107). The adhesive, as previously described may be one of a variety of polymeric adhesives, with an acrylic adhesive being particularly suited for use in the invention. The adhesive is applied to the front or face surface of the substrate 10, only.

Next, fibers 22 having a base color are introduced onto the adhesive using any known flocking process, including but not limited to electrostatic flocking to form a continuous sheet of surface covering (step 108). The continuous sheet of surface covering may optionally be rolled onto a web to form a roll of base covering 2 (step 109).

A design may optionally be applied to the fibers 22 of the base covering 2 to provide an aesthetic appearance (step 110). The design may be applied using a screen printing technique, or alternatively may be applied using a dye sublimation process, wherein dye is first printed onto a transfer medium such as a transfer paper, then the transfer medium is disposed against the fibers 22 and heat is applied. The design application at step 110 may be accomplished at the point and time of manufacturing the base covering 2 or alternatively at another place and/or time as will be described below.

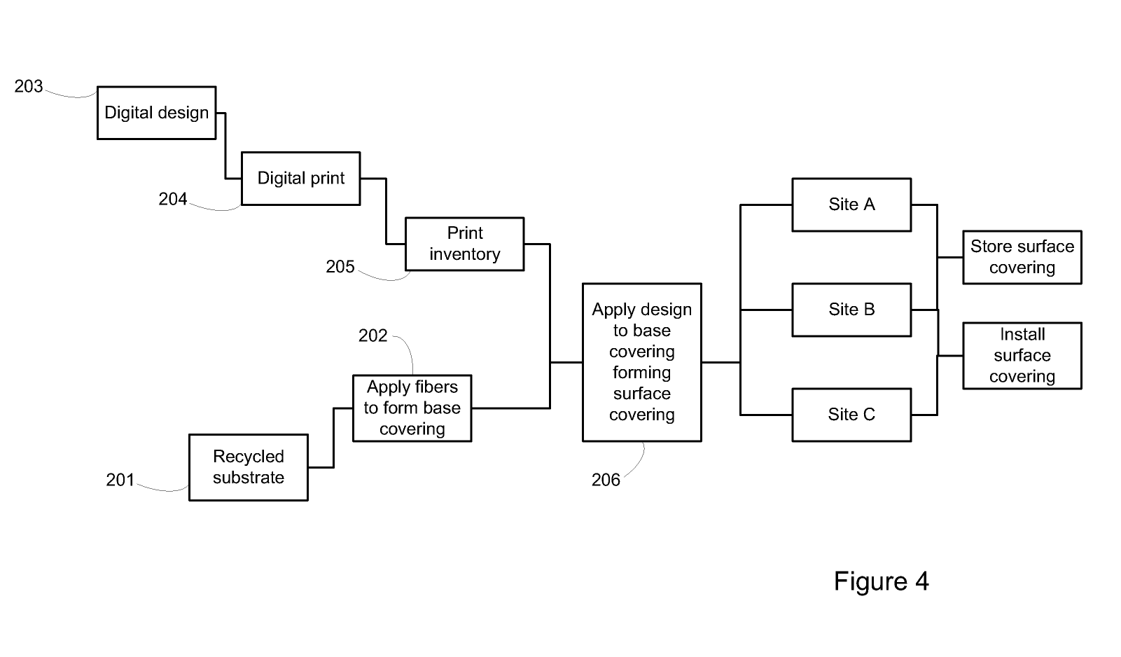

Turning now to FIG. 4, a further variation to the method of manufacturing and distribution will be described. This variation provides greater flexibility in decorative design variations and the ability to more quickly produce and deliver custom designs. In this method, a supply of recycled rubber substrate is produced (step 201) according to steps 101-106. The base covering 2 is then formed by application of the fibers 22 (step 202) according to steps 101-109. In a parallel process, decorative designs are created, by, for example, a digital print design process (step 203). Once the digital design is created, a digital print or transfer medium/paper is made (step 204). The transfer papers may be inventoried (step 205). Dye sublimation transfer equipment may be located at various distribution centers where the transfer papers and base coverings 2 are sent. There, the decorative design is applied to the base covering (step 206) to form the surface covering according to step 110. It can be appreciated that the distribution centers can stock a large number of transfer papers and thus be capable of a larger number of decorative designs as the transfer papers are much smaller than the end product surface covering 1. It can also be appreciated that steps 203-206 may optionally be accomplished in a single facility. One the finished surface covering 1 is completed at step 206, is may be sent to various sites (Sites A, B, C . . . ) for storage and/or installation (steps 207-208).

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A surface covering, comprising:
a substrate formed at least partially from granulated recycled rubber and a binding agent;
a flocking layer adhered to the substrate with an adhesive to form a base covering and
a decorative design is applied to the base covering.

2. The surface covering of claim 1, wherein the binding agent is urethane.

3. The surface covering of claim 1, wherein the adhesive is an acrylic adhesive

4. The surface covering of claim 1, wherein the substrate is shaved from a cylindrical billet of granulated recycled rubber.

5. The surface covering of claim 1, wherein the substrate comprises granulated recycled rubber from recycled surface covering.

6. The surface covering of claim 5, wherein the substrate further comprises granulated recycled rubber from other sources.

7. The surface covering of claim 5, wherein the substrate further comprises a filler.

8. The surface covering of claim 5, wherein the substrate comprises at least 10 wt-% of reground rubber from recycled surface covering.

9. The surface covering of claim 1, wherein a decorative design is formed on the flocking layer.

10. The surface covering of claim 9, wherein the decorative design is formed using a dye sublimation process.

11. The surface covering of claim 9, wherein the decorative design comprises a picture.

12. The surface covering of claim 9, wherein the decorative design comprises a pattern.

13. A method of manufacturing a recyclable surface covering comprising flocking adhered to a granulated recycled rubber substrate, comprising the steps of:
producing a substrate formed at least partially from granulated recycled rubber and a binding agent;
flocking the substrate with fibers of a selected base color to form a base covering;
printing a transfer paper with a design; and
transferring the design from the transfer paper to fibers of the base covering.

14. The method of claim 13 wherein the base covering is warehoused prior to printing.

15. The method of claim 14 wherein a number of transfer papers are printed and stored.

16. The method of claim 15 wherein the base covering is produced in a first facility and then shipped to a distribution center for printing.

17. The method of claim 16 wherein the transfer papers are stored at the distribution facility.
